(19) United States
(12) Patent Application Publication
(10) Pub. No.: US 2016/0240111 A1
(43) Pub. Date: Aug. 18, 2016

(54) PERFORATED LABEL ASSEMBLY

(71) Applicant: Karen Rachel Beber Futernick, Key Biscayne, FL (US)

(72) Inventor: Karen Rachel Beber Futernick, Key Biscayne, FL (US)

(21) Appl. No.: 14/940,796

(22) Filed: Nov. 13, 2015

Related U.S. Application Data
(60) Provisional application No. 62/190,540, filed on Jul. 9, 2015.
(60) Provisional application No. 62/117,709, filed on Feb. 18, 2015.

(51) Int. Cl. G09F 3/00

(52) U.S. Cl. CPC G09F 3/0288

(57) ABSTRACT

A perforated label assembly includes a label member including a primary label portion and a severable label portion; the primary label portion and the severable label portion are disposed in spaced relation and adjoined via an alignment strip; the alignment strip being removable from the label assembly via perforation; the primary label portion corresponding to a primary portion of an electrical apparatus to which the label will be affixed, the severable label portion corresponding to a severable portion of the same; an adhesion strength between the label member and the backing being less than a perforation strength of the alignment strip; an adhesion strength between the label member and the electrical apparatus being higher than a perforation strength of the alignment strip.

### CLAIM OF PRIORITY

The present patent application claims priority pursuant to 35 U.S.C. Section 119(e) to currently pending and prior filed provisional patent application having Ser. No. 62/117,709 filed on Feb. 18, 2015, as well as to currently pending and prior filed provisional application having Ser. No. 62/190,540 filed on Jul. 9, 2015, the contents of which are both explicitly incorporated herein by reference in their entireties.

### BACKGROUND OF THE INVENTION

1. Field of the Invention

The present invention is directed to perforated label assemblies and particularly those perforated label assemblies adapted to be applied to multi-portioned surfaces.

2. Description of the Related Art

One particular application of the present invention may be as a label assembly for electrical apparatus such as AC/DC converters for electronic devices. Many popular electronic devices include the same or substantially similar AC/DC converters, making it difficult to tell one user's from another's. Additionally, many AC/DC converters contain severable and/or interchangeable portions such as extension cord modules which are similarly difficult to tell apart. As such, once severed, it is also difficult to determine which severable portion corresponds to which primary portion. The present invention addresses these needs, and others, as will be discussed herein.

### SUMMARY OF THE INVENTION

The present invention is directed to a perforated label assembly which facilitates affixation of the label to multi-portioned surfaces which are severable from one another. As such, the present invention provides for a label assembly which may be removed from its backing as a single member and so affixed to each surface portion concurrently. The present invention also includes alignment strips which may be removed from the assembly after affixation thereof so as to avoid interfering with the severable portions of the surface.

In one embodiment, a label of the present invention is to be affixed to an electrical apparatus such as an AC/DC adapter for an electronic device. As such, many electrical apparatus include multiple portions which are severable and/or interchangeable such as extension cord modules and the like. Additionally, AC/DC adapters for popular electronic devices are identical in appearance and difficult to tell apart at first glance. Thus, in such an embodiment, the present invention may comprise a decorative label for application to an electrical apparatus, as well as a severable portion thereof, which facilitates distinction of an individual's electrical apparatus from others. Furthermore, certain embodiments include structural features which facilitate affixation of the label to the electrical apparatus and severable portions. In one embodiment, the invention comprises a label assembly comprising at least one label member affixed to a backing. The label member may comprises at least one primary portion and at least one severable portion. The label member is configured to be removed from the backing as a single-member, specifically, without separation of the severable label portion from the primary label portion. As such, each of the primary and severable portions of the label member may be affixed to an electrical apparatus concurrently. Furthermore, the label member may be configured to be severable after affixation to the electrical apparatus.

In one preferred embodiment, the primary label portions and severable label portions may be at least partially defined by perforation. Additionally, an alignment strip may be severably disposed between the primary label portions and severable label portions, itself at least partially defined by perforation. The perforation can comprise an alternating pattern of apertures and webs, each having predetermined dimensional quantities such as diameter. The apertures serve to concentrate stresses at the webs, thereby increasing the likelihood that a stress applied to the label member will result in a fracture or tear precisely at the web. A minimum stress required to fracture the web may be referred to as a perforation strength. Thus, in order to ensure that the label member may be easily removed from a backing as a single-member, the present invention is configured such that any forces applied to the label member during removal from the backing will not cause stresses in the webbing higher than the perforation strength. The perforation strength may be adjusted via a variety of parameters such as thickness of label members, diameter of perforation, and diameter of web.

In one embodiment, the stresses experienced by the web are reduced below that of the perforation strength via optimization of the adhesion strength of the label member to the backing. The label member includes an adhesive layer on a rear face. The label member, via the adhesive layer, is at least temporarily affixed to the backing, partially to ensure that the label member is not inadvertently affixed to other surfaces, or does not collect debris during storage or transport. The minimum stress required to remove the adhesive layer from the backing may be referred to as an adhesion strength. The adhesion strength may be optimized via selection of appropriate adhesive layer compounds and backing materials. Ideally, a backing material of predetermined surface energy is selected so as to provide a minimally resistant release of the label member therefrom, but temporarily retain the label member on the backing.

Alternatively, any of a variety of known adhesives and backing materials may be used, and the perforation strength itself may be optimized via modulation or variation of the dimensional characteristics of the perforation. For example, in order to increase perforation strength, the aperture diameter may be reduced, the web diameter may be increased, or the thickness of the label member may be increased. Conversely, decreasing perforation strength may be achieved via substantially opposite modulation or variation as recited above.

In additional embodiments, the primary label portion and severable label portion are correspondingly dimensioned and configured with a primary portion and severable portion of an electrical apparatus, with an alignment strip correspondingly dimensioned to an interface of the electrical apparatus portions. Therefore, the primary label portion and severable label portion of the label member of the present invention may be affixed to the corresponding portions of the electrical apparatus concurrently, as a single-member, and via removal of alignment strips from the label member, provide for the severable operation of the electrical apparatus without interference from the label member. Additionally, the alignment strips may facilitate an aesthetically pleasing disposition of the label member upon the electrical apparatus by maintaining a predetermined spacing between each portion of the label member, and allowing a user to apply all such portions at one time.

In an alternative embodiment, the primary label portion and severable label portion are correspondingly dimensioned and configured relative to at least a portion of the interface of the electrical apparatus, allowing the primary and severable label portions to comprise any of a variety of dimensions or configurations within an outer boundary of the primary and severable portions of the electrical apparatus. In a more preferred embodiment, the alignment strip is at least partially configured to correspond to an interface of the electrical apparatus.

In yet another embodiment of the present invention, the invention may take advantage of waste heat produced by the electrical apparatus in order to activate a scented or aromatic compound disposed on or within the label member of the present invention, thereby increasing the emission of scented or aromatic particles from the compound. As such, users will be able to introduce additional functionality into their electrical apparatus via the release of virtually any of a variety of known aromatic compounds during use of the electrical apparatus.

In yet further applications of the present invention, the label member may comprise a photoluminescent compound, or other types of luminescent material, which is capable of emitting light. In one embodiment, a phosphorescent medium is utilized such that the label member may absorb light and re-emit light. As such, the present invention adds additional functionality to the electrical apparatus by facilitating visual location of the apparatus in dark environments.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a plan view of a perforated label assembly according to one embodiment of the present invention.

FIG. 2 is a detail view of the portion of FIG. 1 indicated as 2.

FIG. 3 is a section view taken along line 3-3 of FIG. 2.

FIG. 4 is a plan view of a label member affixed to an electrical apparatus according to one embodiment of the present invention.

FIG. 5 is a plan view of a label member affixed to an electrical apparatus according to one embodiment of the present invention.

FIG. 6 is a plan view of a label member affixed to an electrical apparatus according to one embodiment of the present invention.

FIG. 7 is a plan view of a perforated label assembly according to another embodiment of the present invention.

FIG. 8 is a plan view of a perforated label assembly according to yet another embodiment of the present invention.

Like reference numerals refer to like parts throughout the several views of the drawings.

### DETAILED DESCRIPTION OF THE PREFERRED EMBODIMENT

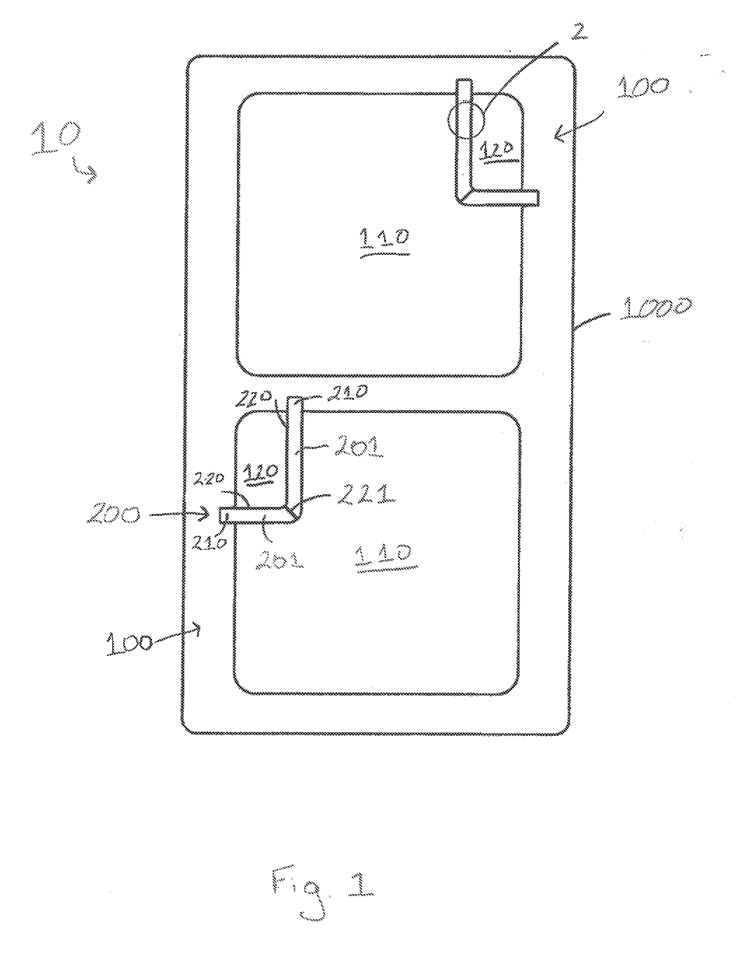

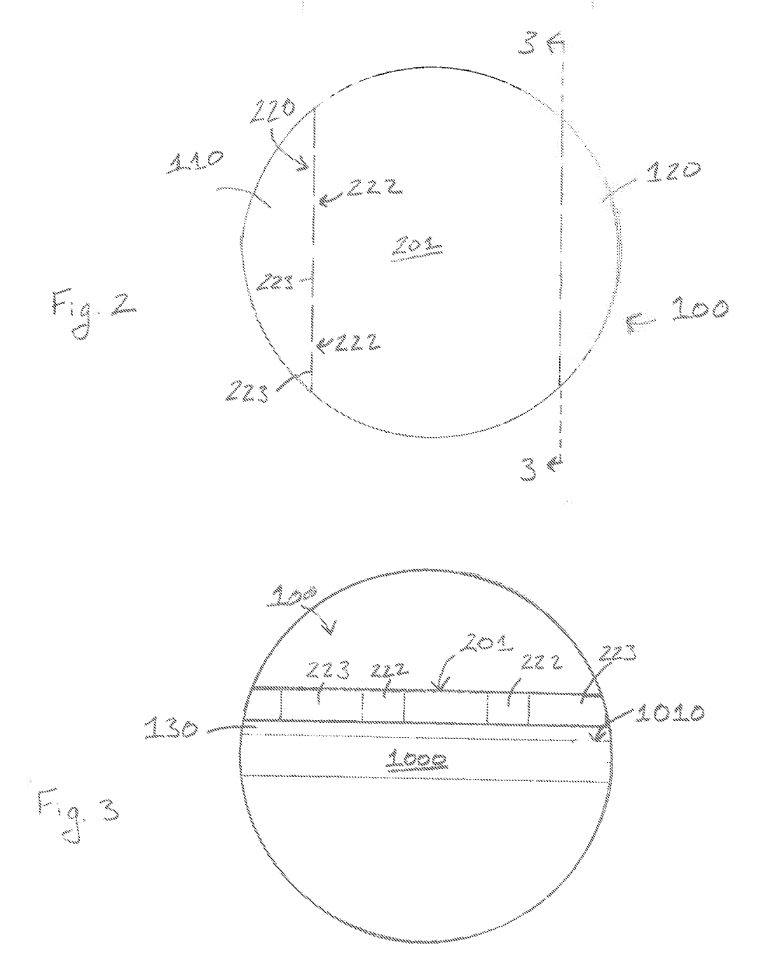

FIG. 1 is a plan view of a perforated label assembly 10 in accordance with one embodiment of the present invention. The label assembly 10 includes a backing 1000 and two label members 100. Each label member 100 is configured and dimensioned to be applied to a portion of an electrical apparatus (as depicted in FIGS. 2-4). Each label member 100 includes a primary label portion 110 and severable label portion 120. Each label member 100 also includes an alignment strip 200 including alignment strip portions 201 which are delineated from the label 100 via perforation 220, and from each other via secondary perforation 230. The alignment strip 200 depicted in FIG. 1 is configured in an “L” shaped configuration which corresponds with structuring structural features of the surface to which the label 100 will be applied, as described below. It will be understood that the alignment strip 200 may comprise a variety of dimensions and configurations.

Each alignment strip portion 201 includes a tabbed end 210 which protrudes beyond the boundary of the label member 100. As such, the tabbed end 210 facilitates removal of the alignment strip portion 201 by providing a surface which is easily graspable by a user, once the label member 100 is applied to the desired surface. As such, the label member 100 is configured to be removed from the backing 1000 as a single member.

FIG. 2 depicts a detail of the area of FIG. 1 indicated as 2. Therein, further details of the perforation 220 may be seen. Accordingly, the perforation 220 comprises a plurality of apertures 223 and webs 222 disposed along the perforation 220. As such, when it is desired to remove the alignment strip portion 201, the perforation 220 facilitates an orderly removal by concentrating stresses at each web 222, thereby allowing the alignment strip channel 201 to be torn substantially along the perforation 220.

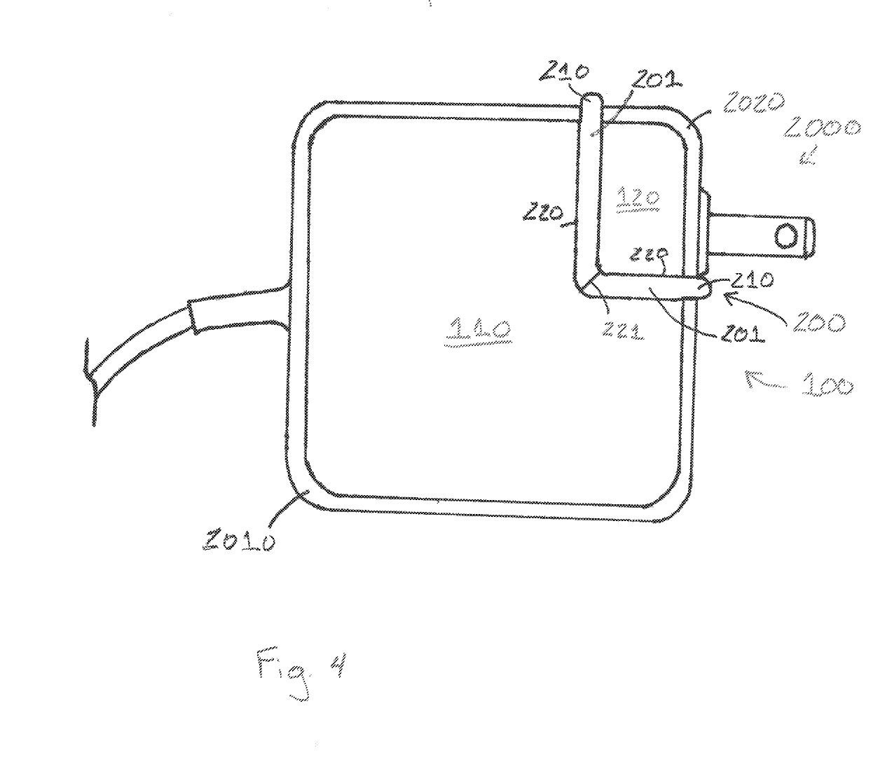

FIG. 3 is a section view taken along line 3-3 of FIG. 2. Therein, it can be seen that the apertures 223 extend through the thickness of the alignment strip portion 201. It will be appreciated that in alternative embodiments the apertures 223 may only extend partially through the alignment strip portion 201 and in yet further embodiments the apertures 223 may extend into the backing 1000, depending at least in part upon manufacturing processes used. It may also be seen that an adhesive coating 130 is applied to the label 100, which is then disposed onto the backing 1000 at an interface 1010. In at least one embodiment, the aperture size, aperture depth, web size, adhesive composition, and backing composition are cooperatively selected such that a force placed on the web 222 during removal of the label 100 from the backing 1000 is less than a force required to tear the webs 222. Stated another way, at least some of the above referenced characteristics are selected such that a failure stress of the webs 223 is larger than the actual stress experienced by the webs 223 during removal of the label 100 from the backing 1000. One way to accomplish such a relation may be to optimize the perforations 220, such as optimizing the dimensional relationships between apertures 223 and webs 222. Alternatively, one method might focus on reducing an adhesion strength between the adhesive layer 120 and backing 1000 at the interface 1010. However, it will be appreciated that other dimensional and compositional relationships may also accomplish the goals of the present invention.

In an additional embodiment, the adhesion strength between the adhesive coating 130 and the electrical apparatus is larger than the adhesion strength at the interface 1010. Indeed, the adhesion strength between the adhesive coating 130 and the electrical apparatus may be larger than the perforation strength such that, after application of the label member 100 to the electrical apparatus, the alignment strip 200 may be removed by simply peeling it away from the electrical apparatus, tearing the perforation 220, and leaving the desired primary label portion 110 and severable label portion 120 of the label member 100 adhered to the electrical apparatus.

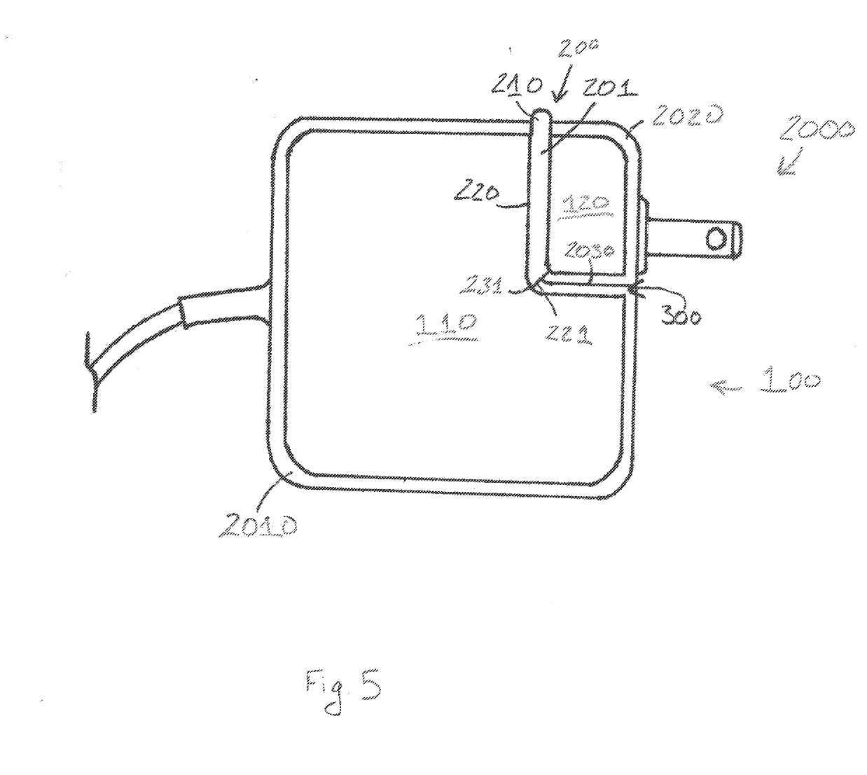

FIG. 4 is a plan view of one embodiment of a label member 100 of the present invention affixed to an electrical apparatus 2010. As can be seen, the label member 100 has been removed from the backing 1000 (depicted in FIG. 1) and affixed to the electrical apparatus 2010 as a single member, with alignment strip 200 connected to the primary label portion 110 and severable label portion 120.

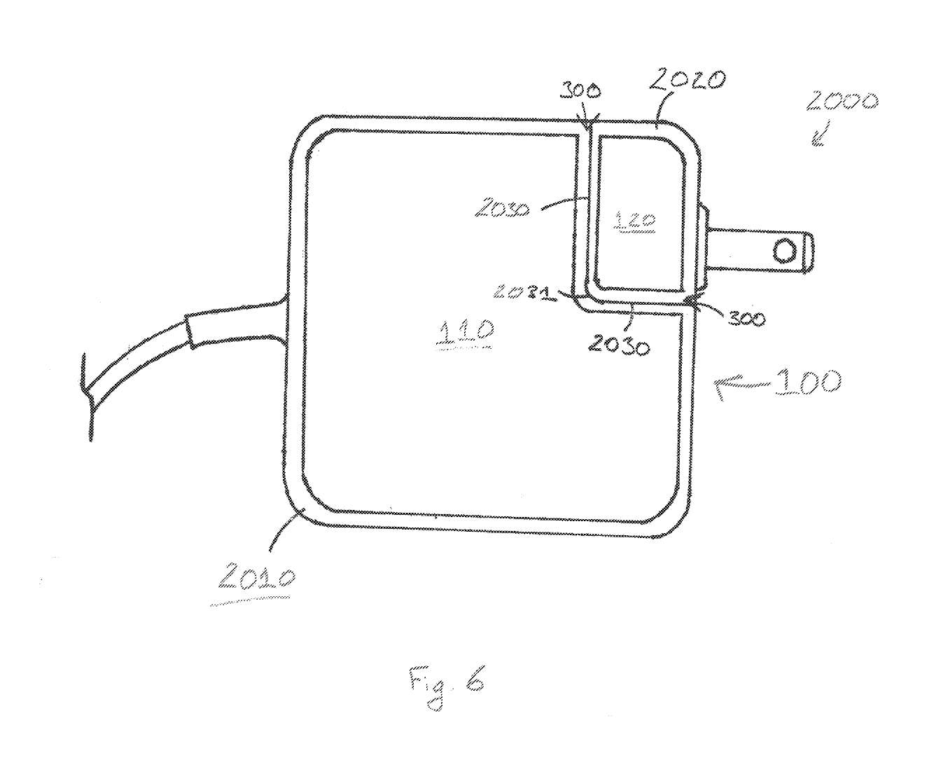

FIG. 5 is a plan view of one embodiment of a label member 100 of the present invention affixed to an electrical apparatus 2010 and having an alignment strip portion 201 removed. In at least one embodiment, the alignment strip portion 201 may be removed by grasping the tabbed portion 210 and pulling, thereby separating the alignment strip portion 201 from the label member 100 at the perforations 220. Additionally, as the depicted alignment strip is “L” shaped, a secondary perforation 230 may be disposed at an angled or radiused portion 231 therof so as to avoid unintentional tearing of the alignment strip portion 201 as it is removed.

One feature of the present invention is the provision of an alignment spacing 300 due to removal of the alignment strip 200. As can be seen, the electrical apparatus 2000 includes a primary portion 2010 and a secondary portion 2020, which interconnect via an interface 2030. The alignment strip 200 is correspondingly disposed and dimensioned to overlie the interface 2030 and provide a desired positioning of the primary label portion 110 and severable label portion 120 relative to the interface. As such, once the alignment strip 200 is removed, an alignment spacing 300 is provided such that the label member 100 does not interfere with operation or separation of the electrical apparatus 2000.

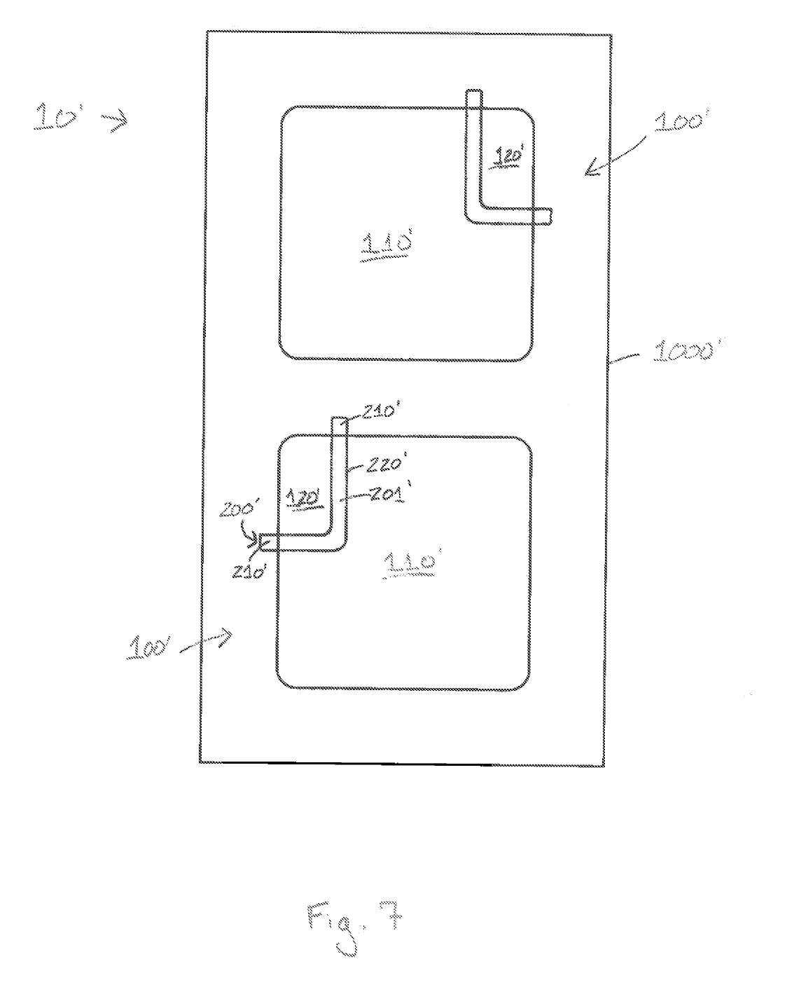

FIG. 6 is a plan view of one embodiment of a label member 100 affixed to an electrical apparatus 2000 and having alignment strip portions removed. As such, no portion of the label member 100 occupies the alignment spacing 300, and the severable portion 2020 of the electrical apparatus 2000 may be severed and/or replaced without interference from the label member 100 of the present invention. Additionally, the primary label portion 110 and severable label portion 120 maintain a predetermined distance relative to both the interface 2030 and the outer boundary of the electrical apparatus 2000. Such an orientation is facilitated by the single-member application of the label member 100, as opposed to individually applying the primary label portion 110 and severable label portion 120. As such, a precise and aesthetically pleasing arrangement of the label member 100 may be achieved via a substantially centered disposition of the single-member label member 100 on the electrical apparatus 2000, as well as a provision of a predetermined alignment spacing 300 of a predetermined distance, created from removal of the alignment strip 200.

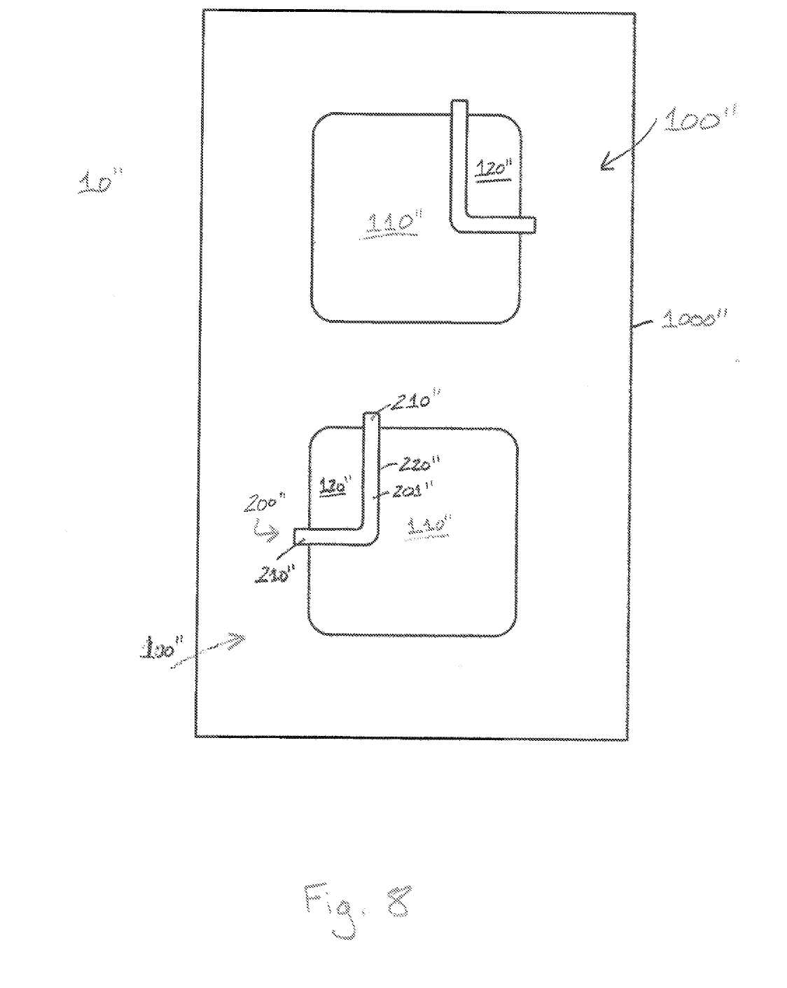

FIGS. 7 and 8 depict alternative embodiments of the present invention comprising different dimensional relationships relative to each other, as well as the embodiment depicted in FIG. 1. As such, the present invention may be easily adapted to fit a variety of electrical apparatus. For example, where the label 100 of FIG. 1 comprises a substantially rounded square shape of approximately 2.5 inches on a side, the label 100′ of FIG. 7 may comprise a dimension of 2.125 inches on a side, and the label 100″ of FIG. 8 may comprise a dimension of 1.75 inches on a side. It will be appreciated that the dimensions of the alignment strip 200, 200′, 200″, such as width and length, may be accordingly adjusted to maintain a proportional relationship to the label 100, 100′, 100″ size and/or corresponding placement relative to an interface of the electrical apparatus.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A perforated label assembly comprising:
a label member including a primary label portion and a severable label portion;
said primary label portion and said severable label portion disposed in spaced relation;
an alignment strip disposed in at least partially interconnecting relation to said primary label portion and said severable label portion; and, said alignment strip being removable from the label assembly.

2. The perforated label assembly as recited in claim 1 further comprising a backing, said label member removably disposed on said backing.

3. The perforated label assembly as recited in claim 2 wherein said alignment strip is at least partially defined via perforation in said label member.

4. The perforated label assembly as recited in claim 3 further comprising an adhesive coating on a back side of said label member; said adhesive coating at least temporarily adhered to said backing.

5. The perforated label assembly as recited in claim 4 wherein said perforation is of sufficient dimensional quantity to resist tearing upon release of said label member from said backing.

6. The perforated label assembly as recited in claim 4 wherein an adhesion strength between said label member and said backing is less than a perforation tear strength as measured between said label member and said alignment strip, facilitating removal of said label member from said backing without tearing of said perforation.

7. The perforated label assembly as recited in claim 6 wherein said label is dimensioned and configured to correspond at least partially to an electrical apparatus comprising a primary portion and a severable portion.

8. The perforated label assembly as recited in claim 7 wherein said perforation tear strength is less than an adhesion strength as measured between said label member and the electrical apparatus, thereby allowing removal of said alignment strip without removal of other portions of said label member.

9. The perforated label assembly as recited in claim 8 wherein said primary portion and said severable portion of said label member are correspondingly dimensioned and configured with a primary portion and a severable portion of the electrical apparatus.

10. The perforated label assembly as recited in claim 9 wherein said alignment strip is correspondingly dimensioned and configured with an interface of the primary portion and severable portion of the electrical apparatus.

11. The perforated label assembly as recited in claim 6 further comprising at least one secondary perforation dividing said alignment strip into a plurality of alignment strip portions.

12. The perforated label assembly as recited in claim 11 wherein said secondary perforation is associated with a radiused portion of said alignment strip.

13. The perforated label assembly as recited in claim 11 wherein said secondary perforation is associated with an angled portion of said alignment strip.

14. The perforated label assembly as recited in claim 1 further comprising at least one tab associated with said alignment strip.

15. The perforated label assembly as recited in claim 15 wherein said at least one tab projects from said label.

16. A label assembly for an electrical apparatus, the electrical apparatus including at least a primary portion and a severable portion, the label assembly comprising:
at least one label member, said label member comprising a primary label portion and a severable label portion;
said primary label portion configured and dimensioned correspondingly with the primary portion of the electrical apparatus; and,
said severable label portion configured and dimensioned correspondingly with the severable portion of the electrical apparatus.

17. The label assembly as recited in claim 16 further comprising an alignment channel disposed at least partially between said primary label portion and said severable label portion.

18. The label assembly as recited in claim 17 wherein said alignment channel is at least partially defined by perforation at least partially through said label member.

19. The label assembly as recited in claim 16 wherein said label member comprises a scented compound.

20. The label assembly as recited in claim 19 wherein said scented compound is at least partially activated via heat produced by the electrical apparatus.

21. The label assembly as recited in claim 21 wherein said label member comprises a photoluminescent compound.
